(19) United States
(12) Patent Application Publication
(10) Pub. No.: US 2017/0080989 A1
(43) Pub. Date: Mar. 23, 2017

(54) CONTROLLABLE EXPANDABLE FOOT FOR LIMBED VEHICLE

(71) Applicant: Elwha LLC, Bellevue, WA (US)

(72) Inventors: William David Duncan, Mill Creek, WA (US); Roderick A. Hyde, Redmond, WA (US); David B. Tuckerman, Lafayette, CA (US); Lowell L. Wood, JR., Bellevue, WA (US)

(73) Assignee: Elwha LLC,

(21) Appl. No.: 14/862,331

(22) Filed: Sep. 23, 2015

(51) Int. Cl. B62D 57/032

(52) U.S. Cl. CPC B62D 57/032

(57) ABSTRACT

Described embodiments include a system, method, and vehicle. A vehicle includes a chassis and at least two controllable limbs coupled to the chassis. The vehicle includes a respective reconfigurable foot coupled to each limb of the at least two controllable limbs. Each reconfigurable foot has a footprint cross-section configured to expand from a contracted configuration to an expanded configuration in response to a deployment-command signal. The vehicle includes a controller configured to issue the deployment-command signal to expand a reconfigurable foot of a limb of the at least two controllable limbs as the reconfigurable foot approaches a surface. In an embodiment, the vehicle includes a sensor configured to acquire data indicative of an aspect of the surface. In an embodiment, the vehicle includes a non-transitory computer readable storage device configured to store data indicative of an aspect of the surface.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

For example, and without limitation, an embodiment of the subject matter described herein includes a vehicle. The vehicle includes a chassis and at least two controllable limbs coupled to the chassis. The vehicle includes a respective reconfigurable foot coupled to each limb of the at least two controllable limbs. Each reconfigurable foot has a footprint cross-section configured to expand from a contracted configuration to an expanded configuration in response to a deployment-command signal. The vehicle includes a controller configured to issue the deployment-command signal to expand a reconfigurable foot of a limb of the at least two controllable limbs as the reconfigurable foot approaches a surface.

In an embodiment, the vehicle includes a sensor configured to acquire data indicative of an aspect of the surface. In an embodiment, the vehicle includes a non-transitory computer readable storage device configured to store data indicative of an aspect of the surface. In an embodiment, the vehicle includes a receiver configured to receive data indicative of an aspect of the surface.

For example, and without limitation, an embodiment of the subject matter described herein includes a vehicle. The vehicle includes a chassis and a controllable limb coupled to the chassis. The vehicle includes a reconfigurable foot coupled to the controllable limb. The reconfigurable foot has a footprint cross-section configured to expand in response to a deployment-command signal. The vehicle includes a controller configured to issue the deployment-command signal to expand the reconfigurable foot as the reconfigurable foot approaches a surface.

For example, and without limitation, an embodiment of the subject matter described herein includes a method. The method includes receiving data indicative of a first portion of a surface being transited by a vehicle having at least two controllable walking limbs. The method includes issuing a deployment-command signal to a first reconfigurable foot of a first controllable limb of the at least two controllable walking limbs to expand as the first reconfigurable foot approaches the first portion of the surface. The method includes contracting the first reconfigurable foot as the first reconfigurable foot departs the first portion of the surface.

In an embodiment, the method includes receiving data indicative of a second portion of the surface being transited by the vehicle. In this embodiment, the method includes issuing a deployment-command signal to a second reconfigurable foot of a second controllable limb of the at least two controllable walking limbs to expand as the second reconfigurable foot approaches the second portion of the surface. In this embodiment, the method includes contracting the second reconfigurable foot as the second reconfigurable foot departs the second portion of the surface.

For example, and without limitation, an embodiment of the subject matter described herein includes an apparatus. The apparatus includes means for receiving data indicative of a first portion of a surface being transited by a vehicle having at least two controllable walking limbs. The apparatus includes means for issuing a deployment-command signal to a first reconfigurable foot of a first controllable limb of the at least two controllable walking limbs to expand as the first reconfigurable foot approaches the first portion of the surface. The apparatus includes means for contracting the first reconfigurable foot as the first reconfigurable foot departs the first portion of the surface.

In an embodiment, the apparatus includes means for receiving data indicative of a second portion of the surface being transited by the vehicle. In this embodiment, the apparatus includes means for issuing a deployment-command signal to a second reconfigurable foot of a second controllable limb of the at least two controllable walking limbs to expand as the second reconfigurable foot approaches the second portion of the surface. In this embodiment, the apparatus includes means for contracting the second reconfigurable foot as the second reconfigurable foot departs the second portion of the surface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example embodiment 100;

FIG. 2 illustrates an example operational flow 200; and

FIG. 3 illustrates an example apparatus 300.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

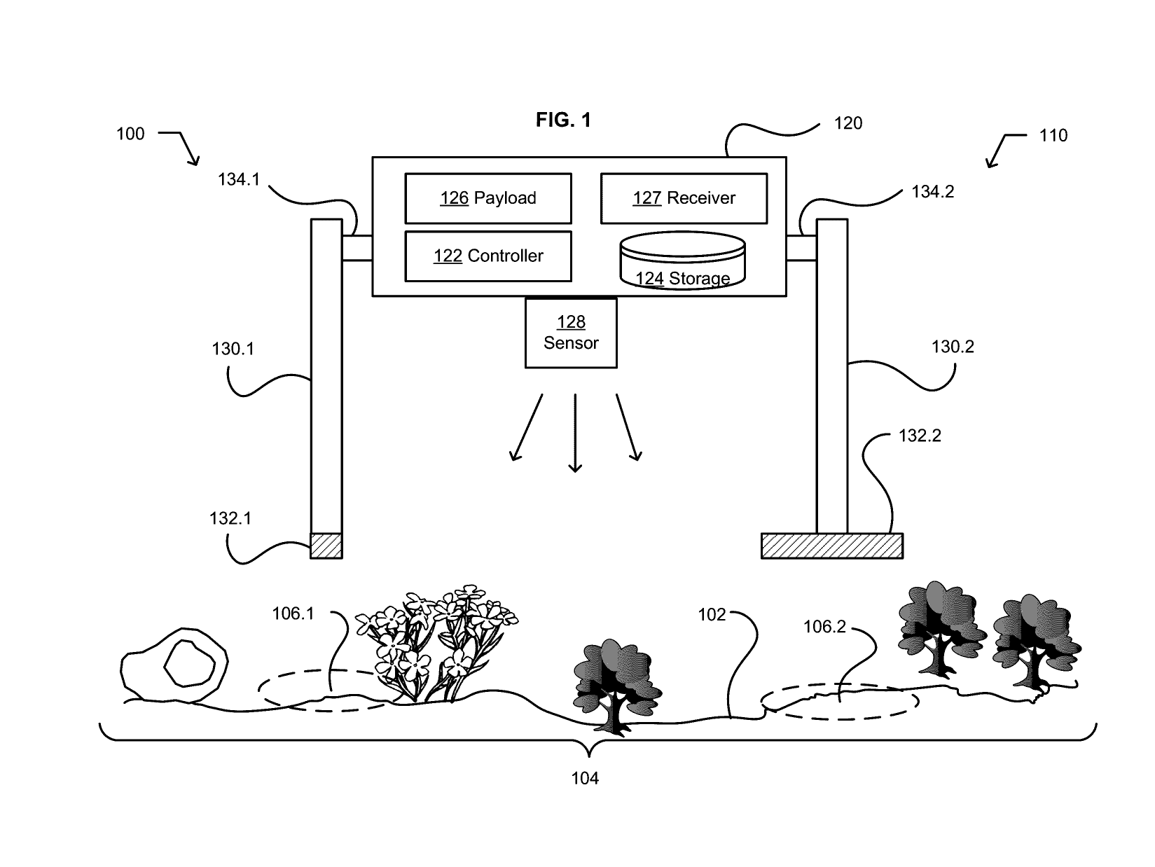

FIG. 1 illustrates an example environment 100 that includes a surface 102 illustrated as a ground surface, objects 104 on the surface illustrated by vegetation and rocks, and a vehicle 110. The vehicle includes a chassis 120, which may be configured to carry a payload 126. For example, the payload may include fruit or vegetables picked from trees or plants growing in the ground, illustrated by the surface 102. For example, the payload may include robotic arms configured to cultivate plants growing in the ground, or to pick fruit or vegetables from those plants. The vehicle includes at least two controllable limbs coupled to the chassis, illustrated as a limb 130.1 and a limb 130.2.

The vehicle 110 includes a respective reconfigurable foot coupled to each limb of the at least two limbs, illustrated by a foot 132.1 in a contracted configuration and coupled to the limb 130.1, and illustrated by a foot 132.2 in an expanded configuration and coupled to the limb 130.2. Each reconfigurable foot having a footprint cross-section configured to expand in response to a deployment-command signal. In an embodiment, each reconfigurable foot has a footprint cross-section configured to expand from a contracted configuration to an expanded configuration in response to the deployment-command signal.

The vehicle 110 includes a controller 122 configured to issue the deployment-command signal to expand a reconfigurable foot of a limb of the at least two limbs (130.1, 130.2) as the reconfigurable foot approaches the surface 102. In an embodiment, the deployment-command signal is issued in response to a proximity of the foot to the surface. In an embodiment, the deployment-command signal is issued in response to a distance or projected time before a landing on the surface by the foot. In an embodiment, the controller includes an open-loop controller. In an embodiment, the controller includes a closed-loop controller. In an embodiment, the controller is configured to issue the deployment-command signal to expand the respective reconfigurable foot of each limb of the at least two limbs as the respective reconfigurable foot approaches the surface. For example, in an embodiment, the reconfigurable foot descends toward the surface in a tightly packaged peg-like configuration (illustrated by reconfigurable foot 132.1) to get past plant canopies without damaging them. Then, before the reconfigurable foot contacts the surface, or at least carries any load, it expands its surface area (illustrated by reconfigurable foot 132.2) increasing its contact or footprint on the surface. In an embodiment, the expansion may include splaying members out sideways, or extending a number of toepads. In an embodiment, this expansion is “smart”; the foot uses cameras or other sensors to extend each toepad in a direction and length so as to miss the stems or trunks of objects 104.

In an embodiment, the vehicle 110 includes a device or structure used to carry or transport people, goods, or things. For example, the vehicle may be used on dry land or may be used on submerged lands, for example to harvest shellfish. In an embodiment, the vehicle includes a self-propelled conveyance. In an embodiment, the chassis 120 includes a base frame of the vehicle or a structural framework of the vehicle. In an embodiment, the surface 102 may include a surface with uncertain or unknown conditions, such as a rough surface or a slippery surface.

In an embodiment, the vehicle 110 includes a robotic vehicle. In an embodiment, the robotic vehicle includes a semiautonomous robotic vehicle. In an embodiment, the robotic vehicle includes an autonomous robotic vehicle. In an embodiment, the robotic vehicle is configured to operate in an agricultural environment. In an embodiment, the robotic vehicle is configured to operate in an orchard environment. In an embodiment, the robotic vehicle is configured to operate in a farm environment.

In an embodiment, the at least two controllable limbs, illustrated by controllable limbs 130.1 and 130.2, include at least two controllable walking limbs. In an embodiment, the at least two controllable limbs include at least two controllable propulsion limbs. In an embodiment, the at least two controllable limbs are configured to move the vehicle 110 over the surface 102. For example, the at least two controllable limbs are configured to provide a dynamic locomotion of the vehicle over the surface. In an embodiment, the at least two controllable limbs include at least two controllable stance limbs. In an embodiment, the at least two controllable limbs are configured to move the vehicle in any direction across the surface.

In an embodiment, the at least two controllable limbs (illustrated by the controllable limbs 130.1 and 130.2) coupled to the chassis 120 include at least three controllable limbs coupled to the chassis. In an embodiment, the at least two controllable limbs coupled to the chassis include at least four controllable limbs coupled to the chassis. In an embodiment, the at least two controllable limbs coupled to the chassis include at least six controllable limbs coupled to the chassis. In an embodiment, a limb of the at least two controllable limbs includes a multi-segment limb. In an embodiment, a limb of the at least two controllable limbs includes a hip and foot configuration. In an embodiment, a limb of the at least two controllable limbs includes a hip, ankle, and foot configuration. A hip is illustrated by a hip 134.1 coupling the limb 130.1 to the chassis 120, and another hip 134.2 coupling the limb 130.2 to the chassis. In an embodiment, a limb of the at least two controllable limbs includes a hip, knee, ankle, and foot configuration. In an embodiment, a limb of the at least two controllable limbs is configured to move in three-dimensions relative to the chassis. In an embodiment, a limb of the at least two limbs is configured to extend and retract along a longitudinal axis of the limb in response to another command signal.

In an embodiment, the reconfigurable foot (illustrated by reconfigurable foot 132.1 or 132.2) includes a reconfigurable foot having a footprint cross-sectional profile configured to expand in response to the deployment-command signal. In an embodiment, the expansion may be in part or wholly achieved using a mechanism or a pneumatic mechanism. In an embodiment, the reconfigurable foot includes a reconfigurable foot having a footprint cross-sectional profile configured to expand into selected portions of the surface 102 free from roots or other objects. In an embodiment, the reconfigurable foot includes extendable toes. In an embodiment, the extendable toes includes smart extendable toes configured to expand into selected portions of the surface free from roots or other objects, or to compensate for roots or other objects on the surface. In an embodiment, the reconfigurable foot of a limb of the at least two limbs includes at least one extendable toepad. For example, an extendable toepad may include an inflatable toe pad or mechanically extendable support structures. In an embodiment, the reconfigurable foot of a limb includes a gripping spike or cleat. In an embodiment, the gripping spike or cleat may be an extendable gripping spike or cleat. For example, a gripping spike or cleat may also be used to till or aerate the soil. In an embodiment, the expanded foot has a footprint cross-section configured to provide a physical support to the vehicle 110 if the expanded foot is in contact with the surface. In an embodiment, the reconfigurable foot of a limb is further configured to contract. In an embodiment, the reconfigurable foot is configured to contract in response to a retraction-command signal issued by the controller 122. In an embodiment, the refraction-command signal is responsive to a determined aspect of the surface. In an embodiment, the reconfigurable foot is configured to automatically contract in response to the reconfigurable foot leaving the surface. In an embodiment, a contracted foot has a minimized or compacted footprint cross-section configured to increase clearance when stepping through vegetative canopies or foliage. For example, a contracted foot is expected to reduce damage to vegetative canopies or other objects proximate to the surface. For example, a contracted foot is expected to avoid plant damage while descending through vegetative canopies or foliage.

In an embodiment, the controller 122 is configured to determine an aspect of the surface 102 and in response to the determined aspect issue a deployment-command signal to expand the reconfigurable foot of a limb (illustrated as the reconfigurable foot 132.1 or reconfigurable foot 132.2). In an embodiment, the aspect of the surface includes an aspect of a ground surface. In an embodiment, the aspect of the surface includes an environment of the surface. In an embodiment, the aspect of the surface includes a condition or characteristic of the surface. For example, a condition of the surface may include a texture or composition of a ground surface, a slipperiness of a surface, or a traction provided by a surface. In an embodiment, the aspect of the surface includes a presence or location of plant stalks or trunks. In an embodiment, the aspect of the surface includes a load bearing capacity or a surface type. For example a load bearing capacity may be responsive to a wet or muddy surface. In an embodiment, the aspect of the surface includes a distance between a reconfigurable foot and the surface. In an embodiment, the aspect of the surface includes a velocity between a reconfigurable foot and the surface. In an embodiment, the aspect of the surface includes an object or vegetation between a reconfigurable foot and the surface. In an embodiment, the aspect of the surface includes a feature of the surface.

In an embodiment, the controller 122 is further configured to issue a retraction-command signal to contract the reconfigurable foot of a limb (illustrated as the reconfigurable foot 132.1 or reconfigurable foot 132.2) as the reconfigurable foot departs or lifts-off of the surface 102. In an embodiment, the controller is carried by the chassis 120. In an embodiment, the controller includes a system of sub-controllers, wherein a respective sub-controller of the system of sub-controllers is assigned to each limb of the at least two limbs (illustrated by the controllable limbs 130.1 and 130.2). In an embodiment, the controller is configured to issue the deployment-command signal to expand the reconfigurable foot of a limb as the limb lands on a ground or earthen surface. In an embodiment, the controller is configured to issue the deployment-command signal to expand a reconfigurable foot after a foot-contact with the surface and before weight of the vehicle 110 is transferred to the controllable limb. In an embodiment, the controller is responsive to sensor-acquired data indicative of an aspect of the surface. In an embodiment, the controller is configured to determine an aspect of the surface in response to stored data indicative of an aspect of the surface. For example, the stored data may include locally stored data or remotely stored data. In an embodiment, the controller is configured to determine an aspect of the surface in response to data indicative of an aspect of the surface received from an external source. In an embodiment, the controller is further configured to issue a retraction-command signal to contract the reconfigurable foot of a limb as the reconfigurable foot departs the surface.

In an embodiment, the vehicle 110 includes a sensor 128 configured to acquire data indicative of an aspect of the surface 102. In an embodiment, the sensor is configured to acquire data indicative of an aspect of the surface at a possible reconfigurable foot landing site. A possible reconfigurable foot landing site is illustrated by a possible reconfigurable foot landing site 106.1 and by a possible reconfigurable foot landing site 106.2. In an embodiment, the sensor includes a digital imaging device. In an embodiment, the sensor includes a radar or a lidar device. For example, a radar or lidar device allows the sensor to look through foliage before limb descends through it. In an embodiment, the sensor includes an ultrasound device.

In an embodiment, the vehicle 110 includes a non-transitory computer readable storage media 124 configured to store data indicative of an aspect of the surface 102. For example, the storage media may store data indicative of trunk or stalk locations on the surface from a planting file, or a pre-foliage map. For example, the storage media may store data indicative of where the vehicle previously walked, and walk there again. For example, this would limit any plant damage to that location. For example, if the previous path was stable, the vehicle may walk the same path because it remembers the previous foot extension settings, etc.

In an embodiment, the vehicle 110 includes a receiver 127 configured to receive data indicative of an aspect of the surface 102. In an embodiment, the controller 122 is configured to issue the deployment-command signal or a refraction-command signal in response to the received data indicative of an aspect of the surface.

FIG. 1 illustrates an alternative embodiment of the example environment 100 that includes the surface 102, objects 104 on the surface, and the vehicle 110. The vehicle includes a chassis 120, which may be configured to carry a payload 126. The vehicle includes the controllable limb 130.1 coupled to the chassis. The vehicle includes the reconfigurable foot 132.1 coupled to the limb 130.1. The reconfigurable foot has a footprint cross-section configured to expand in response to a deployment-command signal. The vehicle includes the controller 122 configured to issue the deployment-command signal to expand the reconfigurable foot as the reconfigurable foot approaches the surface. In an embodiment, the reconfigurable foot is further configured to contract. In an embodiment, the controller is further configured to issue a retraction-command signal to contract the reconfigurable foot as the reconfigurable foot of the limb departs the surface.

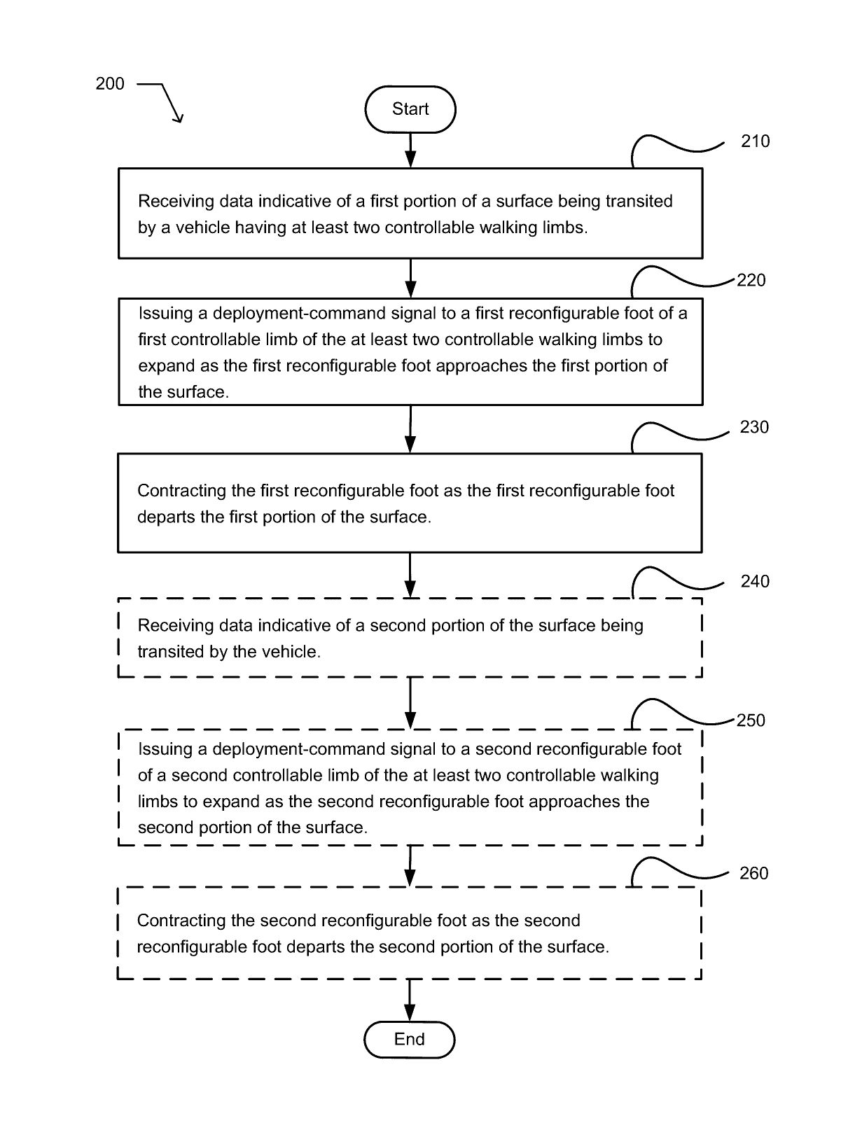

FIG. 2 illustrates an example operational flow 200. After a start operation, the operational flow includes a first reception operation 210. The first reception operation includes receiving data indicative of a first portion of a surface being transited by a vehicle having at least two controllable walking limbs. In an embodiment, the first reception operation may be implemented using the storage 124, the sensor 128, or the receiver 127 described in conjunction with FIG. 1. A first placement operation 220 includes issuing a deployment-command signal to a first reconfigurable foot of a first controllable limb of the at least two controllable walking limbs to expand as the first reconfigurable foot approaches the first portion of the surface. In an embodiment, the first placement operation may be implemented by the controller 122 issuing a first deployment-command signal to the reconfigurable foot 132.1 of the first controllable limb 130.1 to expand as the first reconfigurable foot approaches the first possible reconfigurable foot landing site 106.1 as described in conjunction with FIG. 1. A first removal operation 230 includes contracting the first reconfigurable foot as the first reconfigurable foot departs the first portion of the surface. In an embodiment, the first removal operation may be implemented by the controller 122 issuing a first retraction-command signal to the reconfigurable foot 132.1 of the first controllable limb 130.1 to contract as the first reconfigurable foot departs the first possible reconfigurable foot landing site 106.1 as described in conjunction with FIG. 1. The operational flow includes an end operation.

In an embodiment, the operational flow 200 may include additional operations. In an embodiment, an additional operation includes a second reception operation 240. The second reception operation includes receiving data indicative of a second portion of the surface being transited by the vehicle. In an embodiment, the operational flow 200 includes a second placement operation 250 that includes issuing a deployment-command signal to a second reconfigurable foot of a second controllable limb of the at least two controllable walking limbs to expand as the second reconfigurable foot approaches the second portion of the surface. In an embodiment, the operational flow 200 includes a second removal operation 260 that includes contracting the second reconfigurable foot as the second reconfigurable foot departs the second portion of the surface.

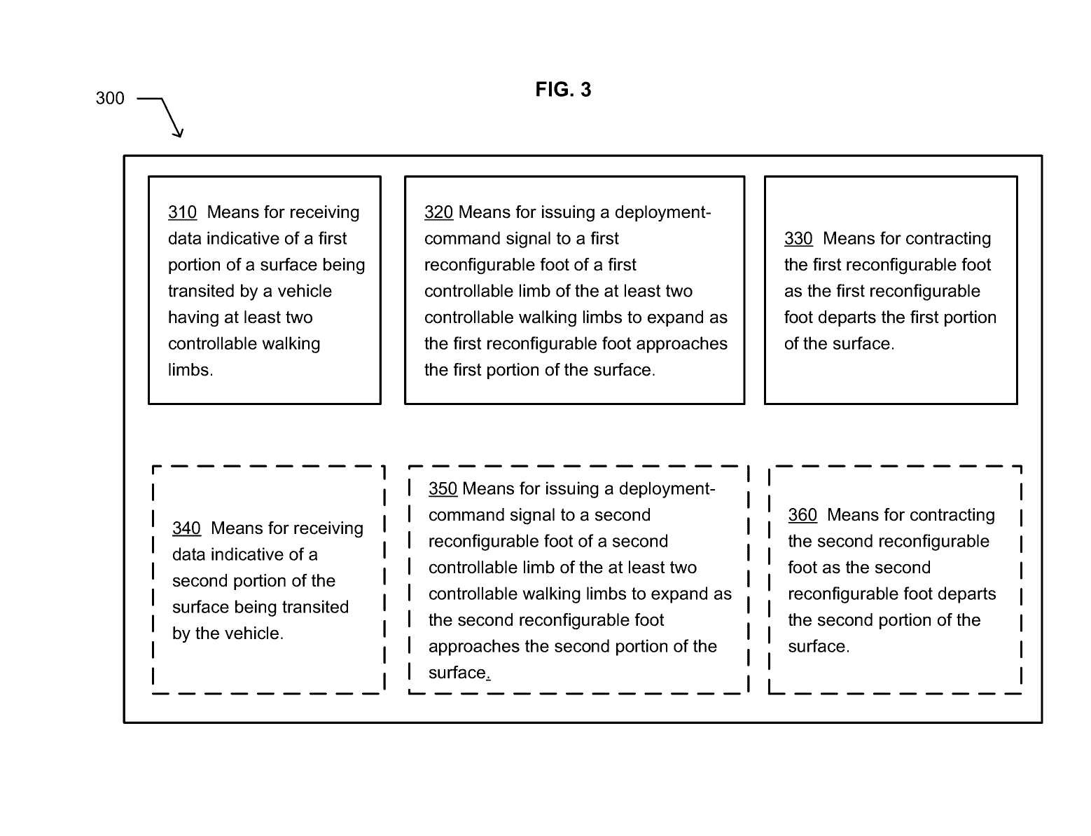

FIG. 3 illustrates an example apparatus 300. The example apparatus includes means 310 for receiving data indicative of a first portion of a surface being transited by a vehicle having at least two controllable walking limbs. The example apparatus includes means 320 for issuing a deployment-command signal to a first reconfigurable foot of a first controllable limb of the at least two controllable walking limbs to expand as the first reconfigurable foot approaches the first portion of the surface. The example apparatus includes means 330 means for contracting the first reconfigurable foot as the first reconfigurable foot departs the first portion of the surface.

In an embodiment, the example apparatus includes means 340 for receiving data indicative of a second portion of the surface being transited by the vehicle. In an embodiment, the example apparatus includes means 350 for issuing a deployment-command signal to a second reconfigurable foot of a second controllable limb of the at least two controllable walking limbs to expand as the second reconfigurable foot approaches the second portion of the surface. In an embodiment, the example apparatus includes means 360 for contracting the second reconfigurable foot as the second reconfigurable foot departs the second portion of the surface.

All references cited herein are hereby incorporated by reference in their entirety or to the extent their subject matter is not otherwise inconsistent herewith.

In some embodiments, “configured” includes at least one of designed, set up, shaped, implemented, constructed, or adapted for at least one of a particular purpose, application, or function.

It will be understood that, in general, terms used herein, and especially in the appended claims, are generally intended as “open” terms. For example, the term “including” should be interpreted as “including but not limited to.” For example, the term “having” should be interpreted as “having at least.” For example, the term “has” should be interpreted as “having at least.” For example, the term “includes” should be interpreted as “includes but is not limited to,” etc. It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “at least two chambers,” or “a plurality of chambers,” without other modifiers, typically means at least two chambers).

In those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A vehicle comprising:
a chassis;
at least two controllable limbs coupled to the chassis;
a respective reconfigurable foot coupled to each limb of the at least two controllable limbs, each reconfigurable foot having a footprint cross-section configured to expand in response to a deployment-command signal; and
a controller configured to issue the deployment-command signal to expand a reconfigurable foot of a limb of the at least two controllable limbs as the reconfigurable foot approaches a surface.

2. The vehicle of claim 1, wherein the vehicle includes a robotic vehicle.

3. The vehicle of claim 2, wherein the robotic vehicle includes a semiautonomous robotic vehicle.

4. The vehicle of claim 2, wherein the robotic vehicle includes an autonomous robotic vehicle.

5. The vehicle of claim 1, wherein the vehicle is configured to operate in an agricultural environment.

6.-7. (canceled)

8. The vehicle of claim 1, wherein the at least two controllable limbs include at least two controllable walking limbs.

9. The vehicle of claim 1, wherein the at least two controllable limbs include at least two controllable propulsion limbs.

10.-11. (canceled)

12. The vehicle of claim 1, wherein the at least two controllable limbs are configured to move the vehicle in any direction across the surface.

13. The vehicle of claim 1, wherein the at least two controllable limbs coupled to the chassis include at least three controllable limbs coupled to the chassis.

14. The vehicle of claim 1, wherein the at least two controllable limbs coupled to the chassis include at least four controllable limbs coupled to the chassis.

15. (canceled)

16. The vehicle of claim 1, wherein a limb of the at least two controllable limbs includes a multi-segment limb.

17. The vehicle of claim 1, wherein a limb of the at least two controllable limbs includes a hip and foot configuration.

18. The vehicle of claim 17, wherein a limb of the at least two controllable limbs includes a hip, ankle and foot configuration.

19. (canceled)

20. The vehicle of claim 1, wherein a limb of the at least two controllable limbs is configured to move in three-dimensions relative to the chassis.

21. The vehicle of claim 1, wherein a limb of the at least two controllable limbs is configured to extend and retract along a longitudinal axis of the limb in response to another command signal.

22. The vehicle of claim 1, wherein the reconfigurable foot includes a reconfigurable foot having a footprint cross-sectional profile configured to expand in response to the deployment-command signal.

23. (canceled)

24. The vehicle of claim 1, wherein the reconfigurable foot of a limb of the at least two controllable limbs includes at least one extendable toepad.

25. The vehicle of claim 1, wherein the reconfigurable foot of a limb includes a gripping spike.

26. The vehicle of claim 1, wherein the expanded foot has a footprint cross-section configured to provide a physical support to the vehicle if the expanded foot is in contact with a surface.

27. The vehicle of claim 1, wherein the reconfigurable foot of a limb is further configured to contract.

28.-30. (canceled)

31. The vehicle of claim 27, wherein a contracted foot has a minimized footprint cross-section configured to clear vegetative canopies.

32. The vehicle of claim 1, wherein the controller is configured to determine an aspect of the surface and in response to the determined aspect issue a deployment-command signal to expand the reconfigurable foot of a limb.

33. The vehicle of claim 32, wherein the aspect of the surface includes an aspect of a ground surface.

34.-35. (canceled)

36. The vehicle of claim 32, wherein the aspect of the surface includes a presence or location of plant stalks or trunks.

37. The vehicle of claim 32, wherein the aspect of the surface includes a load bearing capacity or a surface type.

38. (canceled)

39. The vehicle of claim 32, wherein the aspect of the surface includes a velocity between a reconfigurable foot and the surface.

40. The vehicle of claim 32, wherein the aspect of the surface includes an object or vegetation between a reconfigurable foot and the surface.

41. (canceled)

42. The vehicle of claim 1, wherein the controller is further configured to issue a retraction-command signal to contract the reconfigurable foot of a limb as the reconfigurable foot departs the surface.

43. (canceled)

44. The vehicle of claim 1, wherein the controller includes a system of sub-controllers, wherein a respective sub-controller of the system of sub-controllers is assigned to each limb of the at least two controllable limbs.

45. The vehicle of claim 1, wherein the controller is configured to issue the deployment-command signal to expand the reconfigurable foot of a limb as at least a portion of the limb or the reconfigurable foot lands on the ground or earthen surface.

46. (canceled)

47. The vehicle of claim 1, wherein the controller is responsive to sensor-acquired data indicative of an aspect of the surface.

48.-49. (canceled)

50. The vehicle of claim 45, wherein the controller is further configured to issue a retraction-command signal to contract the reconfigurable foot of a limb as the reconfigurable foot departs the surface.

51. The vehicle of claim 1, further comprising:
a sensor configured to acquire data indicative of an aspect of the surface.

52. The vehicle of claim 51, wherein the sensor includes a digital imaging device.

53. The vehicle of claim 51, wherein the sensor includes a radar or a lidar device.

54. The vehicle of claim 51, wherein the sensor includes an ultrasound device.

55. The vehicle of claim 1, further comprising:
a non-transitory computer readable storage device configured to store data indicative of an aspect of the surface.

56. The vehicle of claim 1, further comprising:
a receiver configured to receive data indicative of an aspect of the surface.

57. (canceled)

58. A vehicle comprising:
a chassis;
a controllable limb coupled to the chassis;
a reconfigurable foot coupled to the controllable limb, the reconfigurable foot having a footprint cross-section configured to expand in response to a deployment-command signal; and
a controller configured to issue the deployment-command signal to expand the reconfigurable foot as the reconfigurable foot approaches a surface.

59. The vehicle of claim 58, wherein the reconfigurable foot is further configured to contract.

60. The vehicle of claim 58, wherein the controller is further configured to issue a retraction-command signal to contract the reconfigurable foot as the reconfigurable foot of the limb departs the surface.

61. A method comprising:
receiving data indicative of a first portion of a surface being transited by a vehicle having at least two controllable walking limbs;
issuing a deployment-command signal to a first reconfigurable foot of a first controllable limb of the at least two controllable walking limbs to expand as the first reconfigurable foot approaches the first portion of the surface; and
contracting the first reconfigurable foot as the first reconfigurable foot departs the first portion of the surface.

62.-64. (canceled)
